(19) United States
(12) Patent Application Publication
(10) Pub. No.: US 2013/0063749 A1
(43) Pub. Date: Mar. 14, 2013

(54) IMAGE FORMING APPARATUS, IMAGE FORMING SYSTEM, AND METHOD OF SETTING OF IMAGE FORMING APPARATUS OPERATION

(71) Applicants: Takashi Ohisa, Sunto-gun (JP); Toshihiro Sone, Yokohama-shi (JP)

(72) Inventors: Takashi Ohisa, Sunto-gun (JP); Toshihiro Sone, Yokohama-shi (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/605,034

(22) Filed: Sep. 6, 2012

Related U.S. Application Data
(60) Provisional application No. 61/532,229, filed on Sep. 8, 2011.

(51) Int. Cl. G06K 15/02

(52) U.S. Cl. 358/1.13; 358/1.15

(57) ABSTRACT

According to one embodiment, an image forming apparatus includes a reception unit, a button setting unit, a storage unit, and a printing unit. The reception unit receives operation setting information including image information of a printing target, printing condition information, and button setting information from an external device. The button setting unit sets a printing instruction button using the button setting information which is included in the operation setting information which is received by the reception unit. The storage unit stores the image information and the printing condition information in the printing instruction button which is set by the button setting unit to be correlated with each other. The printing unit prints image data which is denoted in the image information according to the printing condition when the printing instruction button is input.

### CROSS-REFERENCE TO RELATED APPLICATIONS

This application is based upon and claims the benefit of priority from U.S. Provisional Application No. 61/532,229 filed on Sep. 8, 2011; the entire contents of which are incorporated herein by reference.

### FIELD

Embodiments described herein relate generally to an image forming apparatus, an image forming system, and a method of setting of an image forming apparatus operation.

### BACKGROUND

There is a case in which printed matter such as a brochure or the like is distributed to visitors, and attendants in a conference hall, an exhibition hall, a concert hall, and a variety of event halls. In the related art, it is necessary to prepare the printed matter which is distributed to the visitors, or the attendants in advance. However, in practice, it is difficult to prepare just the right amount of printed matter.

### BRIEF DESCRIPTION OF THE DRAWINGS

FIG. 1 is a schematic diagram which illustrates a configuration example of an image forming system according to one embodiment.

FIG. 2 is a block diagram which describes a configuration example of a digital multi-functional peripheral according to the embodiment.

FIG. 3 is a diagram which illustrates a configuration example of an appearance of a control panel according to the embodiment.

FIG. 4 is a diagram which illustrates a configuration example of an appearance of a control panel according to the embodiment.

FIG. 5 is a flowchart which describes an operation example of an external device in an image forming system according to the embodiment.

FIG. 6 is a flowchart which describes an operation example of the digital multi-functional peripheral in the image forming system according to the embodiment.

### DETAILED DESCRIPTION

In general, according to one embodiment, an image forming apparatus includes a reception unit, a button setting unit, a storage unit, and a printing unit. The reception unit receives operation setting information including image information of a printing target, printing condition information, and button setting information from an external device. The button setting unit sets a printing instruction button using the button setting information which is included in the operation setting information which is received by the reception unit. The storage unit stores the image information and the printing condition information, which are correlated with each other, in the printing instruction button which is set by the button setting unit. The printing unit prints image data which is denoted in the image information according to the printing condition when the printing instruction button is input.

Hereinafter, the embodiment will be described in detail while referring to drawings.

First, an image forming system including the image forming apparatus according to the embodiment will be described.

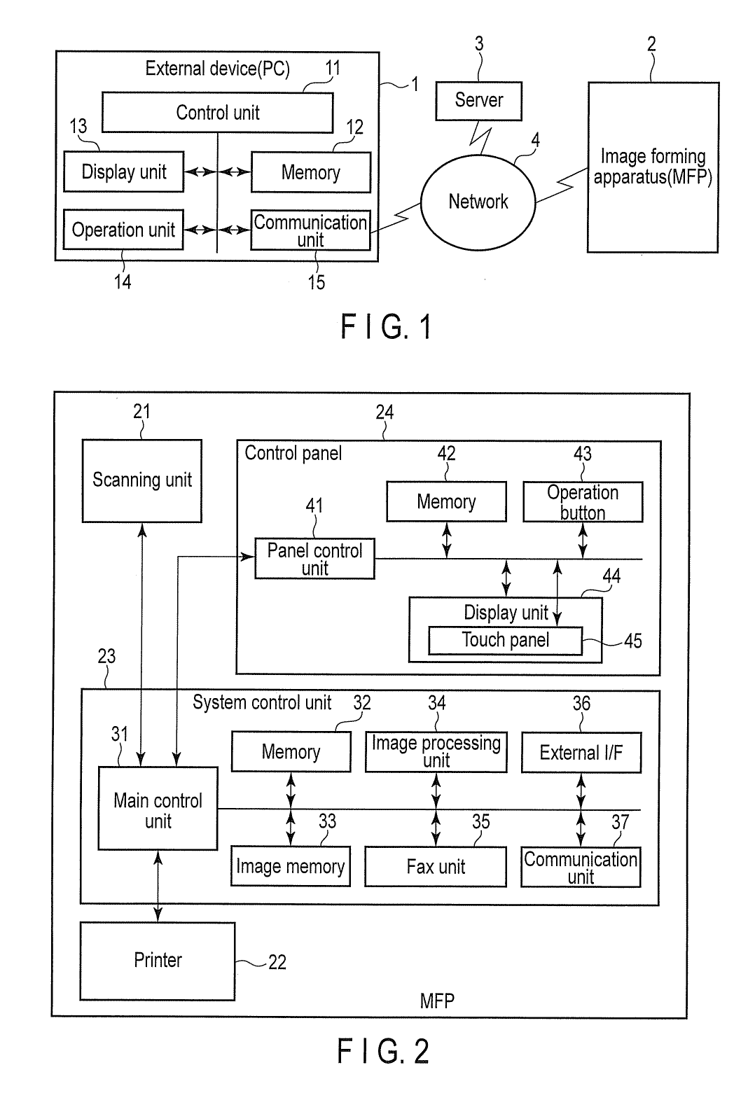

FIG. 1 is a diagram which illustrates a configuration example of the image forming system according to the embodiment.

As illustrated in FIG. 1, the image forming system connects a PC (personal computer) 1 as an external device, an MFP (digital Multi-Functional Peripheral) 2 as the image forming apparatus, and a server 3 through a network 4.

According to the embodiment, the external device 1 may be a device which is able to communicate with the MFP 2 and the server 3 through the network 4, and in which a user is able to input the image information of a printing target, the printing condition, the setting of button (icon), or the like. For example, as the external device 1, it is possible to adopt not only the PC but also a smart phone, a tablet terminal, or other MFPs. According to the embodiment, descriptions are made by setting the external device 1 as a PC.

In addition, the server 3 functions as a data server, or an authentication server in the image forming system. For example, the server 3 may temporarily save data such as the operation setting information which is transmitted to the MFP 2 from the external device 1, or store image data as a printing target of the MFP 2, or the like. In addition, the server 3 may store specification data of each MFP (information denoting executable functions or the like), management information, or the like. In addition, the server 3 may also store information, or the like, which denotes authentication information of a user, an authority level of a user, or the like, as information relating to each MFP 2 in the image forming system. In addition, the server 3 may also perform user authentication processing by receiving an authentication request from the external device 1, or the MFP 2.

Subsequently, a configuration of a PC as the external device 1 will be described.

In the configuration example illustrated in FIG. 1, a PC (external device) 1 includes a control unit 11, a memory 12, a display unit 13, an operation unit 14, and a communication unit 15.

The control unit 11 is in charge of controlling the entire PC 1. The control unit 11 includes a processor such as a CPU, a working memory such as a RAM, and a program memory such as a ROM. The control unit 11 executes various processing functions by executing a program which is stored in the ROM, or the memory 12 by a processor.

The memory 12 is configured by a non-volatile memory which is rewritable, or the like. The memory 12 stores a control program, control data, setting information, and the like which are executed by the control unit 11. In addition, the memory 12 may maintain the operation setting information which is generated by an operation setting program to be described later, display setting information of the display data which is displayed on the display unit of the MFP 2, or the like. The display unit 13 is configured by a display device. The display unit 13 is controlled by the control unit 11, and displays operation guidance, or the like. An operation unit 14 is configured by operation devices such as a keyboard, a pointing device, a touch panel, and the like, which are operated by a user. A user inputs operation instructions for generating operation setting information including display setting information with respect to the display unit of the MFP 2 to be described later, using the display unit 13 and the operation unit 14.

The communication unit 15 is configured by a communication interface. In the configuration example illustrated in FIG. 1, the communication unit 15 is an interface for communicating with the MFP 2 and the server 3 through the network 4. The communication unit 15 may execute a communication with the MFP 2 and the server 3, may be an interface which is connected to the MFP 2 and the server 3 through a communication line, and may be an interface which is connected to the MFP 2 and the server 3 using a radio communication.

Subsequently, a configuration of the MFP 2 as the image forming apparatus will be described.

FIG. 2 is a block diagram which describes a configuration example of the MFP 2.

In the configuration example illustrated in FIG. 2, the MFP (digital multifunctional-peripheral) 2 includes a scanner 21, a printer 22, a system control unit 23, and a control panel 24. In addition, in the configuration example illustrated in FIG. 2, the scanner 21, the printer 22, and the control panel 24 are connected to the system control unit 23.

The scanner 21 is a unit which converts an image of an original document to image data by optically reading the image. The scanner 21 reads an original document which is set on glass of a platen, or an image on the original document surface which is supplied by a document feeder (ADF). For example, the scanner 21 includes a photoelectric conversion unit which is configured by a CCD line sensor which converts an image of one line of an original document in the main scanning direction to image data. The scanner 21 reads the entire image of the original document by scanning the original document using the CCD line sensor in the sub-scanning direction of the original document. The scanner 21 performs scanning of the original document according to the operation instruction from the system control unit 23. The scanner 21 outputs the read image (image data) of the original document to the system control unit 23.

The printer 22 forms an image on a sheet as a medium to be printed with an image. The printer 22 prints an image based on image data which is supplied from the system control unit 23 on a sheet, under various printing conditions which are designated from the system control unit 23. The printing conditions which can be designated to the printer 22 correspond to a specification of the printer 22. For example, if the printer 22 is a color printer, it is possible to designate any of monochrome or color as setting of color. In addition, if the printer has function of double sided printing, it is possible to designate any of the single sided printing, or the double sided printing as setting of the printing surface. In addition, it may be also possible to make a size, a type, or the like of a sheet to be printed with an image to be designated from a sheet which is set in the printer 22.

In addition, printers having various image forming methods can be applied to the printer 22. For example, the printer 22 may be a printer of an electrographic method, an ink jet type, or a printer performing a thermal ink-transfer printing.

In addition, the system control unit 23 performs an overall control of the entire MFP 2. The system control unit 23 is connected to each unit of the MFP 2 such as the scanner 21, the printer 22, and the control panel 24. The system control unit 23 performs an overall control of operations of each unit such as the scanner 21, the printer 22, and the control panel 24.

In the configuration example which is illustrated in FIG. 2, the system control unit 23 includes a main control unit 31, a memory 32, an image memory 33, an image processing unit 34, a FAX unit 35, an external interface (I/F) 36, and a communication unit 37.

The main control unit 31 performs a control of each unit, arithmetic processing, or the like. The main control unit 31 includes a processor such as a CPU, a working memory such as a RAM, and a program memory such as a ROM. The main control unit 31 is connected to the control unit such as the scanner 21, the printer 22, and the control panel 24. The main control unit 31 outputs operation instruction to each unit by performing an interactive communication with the scanner 21, the printer 22, and the control panel 24, or obtains various pieces of information from each unit.

The main control unit 31 executes various processing functions by executing a program which is stored in the ROM or the memory 32 by the processor. For example, the main control unit 31 executes processing functions of reception processing which receives the operation setting information including the display setting information with respect to the display unit 44 from the external device 1, updating processing which updates display contents of a display unit 44 using display data which is created on the basis of the operation setting which is based on the operation setting information received from the external device 1, and the display setting information which is included in the operation setting information received from the external device 1, or the like.

The memory 32 is configured by, for example, a rewritable non-volatile memory. The memory 32 stores control data, a control program, setting information, or the like. The memory 32 may maintain data which is received from the external device 1. The memory 32 stores a set default value in various operation modes or the like, as well.

The image memory 33 is configured by a hard disk drive, a page memory, or the like. The image memory 33 stores a plurality of image data items. The image memory 33 functions as a page memory which develops the image data as a printing target, as well. The image processing unit 34 processes the image data. For example, the image processing unit 34 performs processing of correction, compression, or extension of the image data which is obtained from the outside through the scanner 21, the external device 1, or the network 4, according to properties of the printer 2.

The FAX unit 35 is an interface which performs a communication using a facsimile. The external interface 36 is an interface for connecting external devices. For example, the external interface 36 is configured by an interface for connecting a portable external storage device (storage medium). The communication unit 37 is an interface for performing a data communication with the external device 1.

In addition, the control panel 24 is a user interface which displays guidance to a user, or receives an operation instruction by a user. In the configuration example illustrated in FIG. 2, the control panel 24 includes a panel control unit 41, a memory 42, an operation button 43, a display unit 44, and a touch panel 45.

The panel control unit 41 controls the control panel 24. The panel control unit 41 supplies information which is input to each unit of the control panel 24 to the system control unit 23, and controls the control panel 24 according to a control signal from the system control unit 23. The panel control unit 41 includes a processor such as a CPU, a working memory such as a RAM, a program memory such as a ROM, or the like. The panel control unit 41 executes various processing functions by executing a program which is stored in the ROM or the memory 12 by a processor. For example, the panel control unit 41 updates an operation screen which is displayed on the display unit 44, or detects an input to an icon which is displayed on the operation screen. In addition, the panel control unit 41 performs a control of updating the display screen of the display unit 44 using display data which is supplied from the system control unit 23.

The memory 42 is configured by a rewritable non-volatile memory or the like. The memory 42 stores a control program which is executed by the panel control unit 41, control data, setting information, or the like. In addition, the memory 42 has a storage region which stores display data such as the operation screen which is displayed on the display unit 44.

The operation button 43 is a press button (hard key) which is provided to be fixed. Each key as the operation button 43 may be a start key, a numeric keypad, or a key to which instruction contents are allocated in advance, such as a function selection key, or may be a key to which instruction contents (processing to be executed) are set.

The display unit 44 displays the operation screen, operation guidance, or the like. The display unit 44 includes the touch panel 45 on the display screen. The touch panel 45 detects a portion which is touched by a user on the display screen of the display unit 44. For example, the panel control unit 41 specifies an icon (instruction contents) which is input by a user based on a display position of the icon which is displayed on the display unit 44, and a touch position of a user which is detected by the touch panel 45.

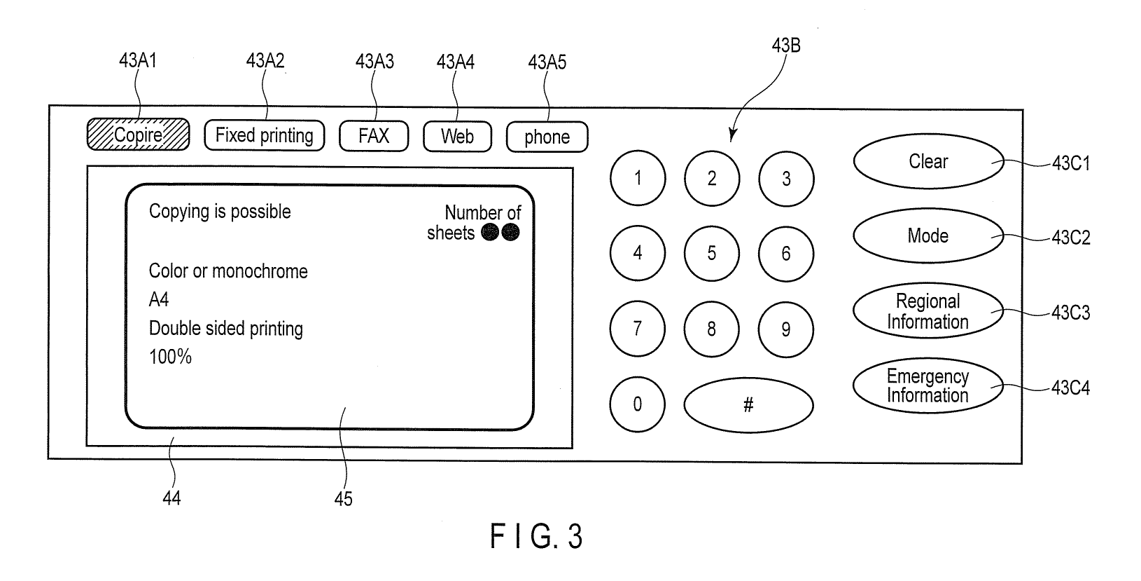

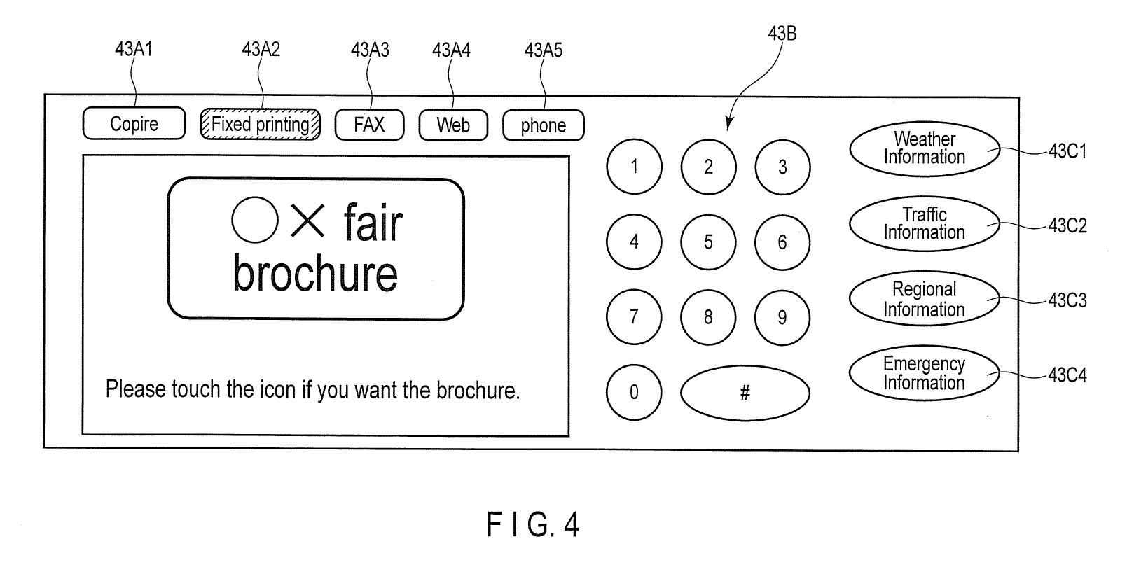

FIGS. 3 and 4 are diagrams which illustrate configuration examples of appearances of the control panel 24.

In the configuration examples illustrated in FIGS. 3 and 4, the control panel 24 is arranged with various operation buttons 43, and the display unit 44 including the touch panel 45. The operation buttons 43 are press buttons which are provided to be fixed. In the configuration example illustrated in FIG. 3, as the operation buttons 43, there are function selection keys 43A (43A1 to 43A4), numeric keypads 43B, and user setting buttons 43C (43C1 to 43C4).

The function selection keys 43A, the numeric keypads 43B, and the user setting buttons 43C (4301 to 4304) are arranged at a fixed position on the control panel 24. However, the function selection keys 43A, the numeric keypads 43B, and the user setting buttons 43C (43C1 to 4304) may be configured by a touch panel or the like, without being limited to the press button.

In the display examples which are illustrated in FIGS. 3 and 4, as the function selection keys 43A, there are a copy key 43A1, a fixed printing key 43A2, a FAX key 43A3, a Web key 43A4, and a phone key 43A4. The copy key 43A1 is a button which is selected when using a function of copying. The fixed printing key 43A2 is a button selected when using a function of printing an image which is saved in the MFP 2 or the server 3, or an image which is obtained through a network. The FAX key 43A3 is a button selected when using a FAX function such as printing of image data which is received through a communication using the facsimile. The Web key 43A4 is a button selected when using a Web function such as a printing of a Web page. The phone key 43A4 is a button selected when using a phone function such as printing of image data which is saved in a mobile device such as a mobile phone.

The display example illustrated in FIG. 3 is a state where the copy key 43A1 is selected. The display example illustrated in FIG. 3 shows a state in which a copy mode is selected as an operation mode of the MFP 2. In addition, the display example illustrated in FIG. 4 is a state in which the fixed printing key 43A2 is selected. The display example illustrated in FIG. 4 shows a state in which a fixed printing mode is selected as the operation mode of the MFP 2. That is, as shown in FIGS. 3 and 4, the function selection key 43A has not only the function of selecting and instructing the operation mode (function), but also the function of denoting the present operation mode of the MFP 2. In addition, when any of operation modes (functions) is unusable (locked), for the function selection key 43A, it may be also possible to make a button for selecting a locked operation mode not to be selected and instructed.

The user setting button 43C is a button with which a user can set processing contents which are instructed using each button. In the display examples illustrated in FIGS. 3 and 4, as the user setting button 43C, a first output button 43C1, a second output button 43C2, a third output button 43C3, and a fourth output button 43C4 are provided.

For example, in the display example illustrated in FIG. 3, the first output button 43C1 is set as a clear button which instructs clearing of the present set contents, or the like. The second output button 43C2 is set as a mode button for instructing when performing setting of operation modes or the like. The third output button 43C3 is set as a “regional information” button which instructs printing of the regional information which is set in advance. The fourth output button 4304 is set as an “emergency information” button which instructs printing of the emergency information which is set in advance.

In addition, in the display example illustrated in FIG. 4, the first output button 4301 is set as a “weather information” button which instructs printing of the weather information which is set in advance. The second output button 43C2 is set as a “traffic information” button which instructs printing of the traffic information which is set in advance. The third and fourth output buttons 4303 and 4304 are set as the “regional information” button and the “emergency information” button, respectively.

The “regional information” button, the “emergency information” button, the “weather information” button, and the “traffic information” button may be set as a button for printing the regional information, the emergency information, the weather information, and the traffic information which are downloaded in the MFP2 or the server 3 in advance, or may be set as a button for printing a specified Web page (Web page which shows regional information, Web page which shows emergency information, Web page which shows weather information, and Web page which shows traffic information) which can be accessed through the network 4.

In addition, in the display unit 44 of the control panel 24, information denoting the present state of the MFP, information denoting the present operation mode and setting contents, icons for inputting the operation instruction, and the like are displayed. For example, the display example illustrated in FIG. 3 is an example of an operation screen which is displayed by the display unit 44 when the MFP 2 is the copy mode. In the display example illustrated in FIG. 3, the display unit 44 displays that the MFP is in a state of enabling copying, and the present set contents are “monochrome, A4, double sided printing, and 100%”. Display data such as operation screens for various functions of the MFP 2 which is displayed by the display unit 44, as shown in FIG. 3, is stored in the memory 32 or the memory 42 in advance.

In addition, the display unit 44 has a function of displaying an operation screen (display data) based on the display setting information including the icon which is created in the external device 1, in addition to the operation screen which is stored in the memory 32 or the memory 42 in advance. For example, the display example illustrated in FIG. 4 is an example in which the display data based on the display setting information including the icon which is created in the external device 1 is displayed in the display unit 44. In the example illustrated in FIG. 4, the display unit 44 displays an icon which instructs printing of a specified image (image of brochure), and a guidance message which guides a printed matter (brochure) which is printed using the icon.

Subsequently, the operation setting processing (display setting and operation setting of control panel) with respect to the MFP 2 in the image forming system will be described.

In the image forming system, the operation setting including the display setting of the display unit 44 in the control panel 24 is performed with respect to the MFP 2 from the external device 1. For example, the external device 1 has a function of setting the icon which is displayed in the display unit 44, and the processing contents which are executed using the icon with respect to the MFP 2. For example, the external device 1 displays the set icon on the display unit 44 of the MFP 2, and causes the MFP 2 to perform printing processing of the image data which is designated under a printing condition designated according to the input to the icon. According to the embodiment, the external device 1 generates the operation setting information denoting the processing contents which are caused to be executed in the MFP 2, and the display setting or the like of the icon displayed in the display unit 44. The MFP 2 performs the operation setting including the display setting of the display unit 44 based on the operation setting information which is generated by the external device 1.

Subsequently, generating processing of the operation setting information in the external device 1 will be described.

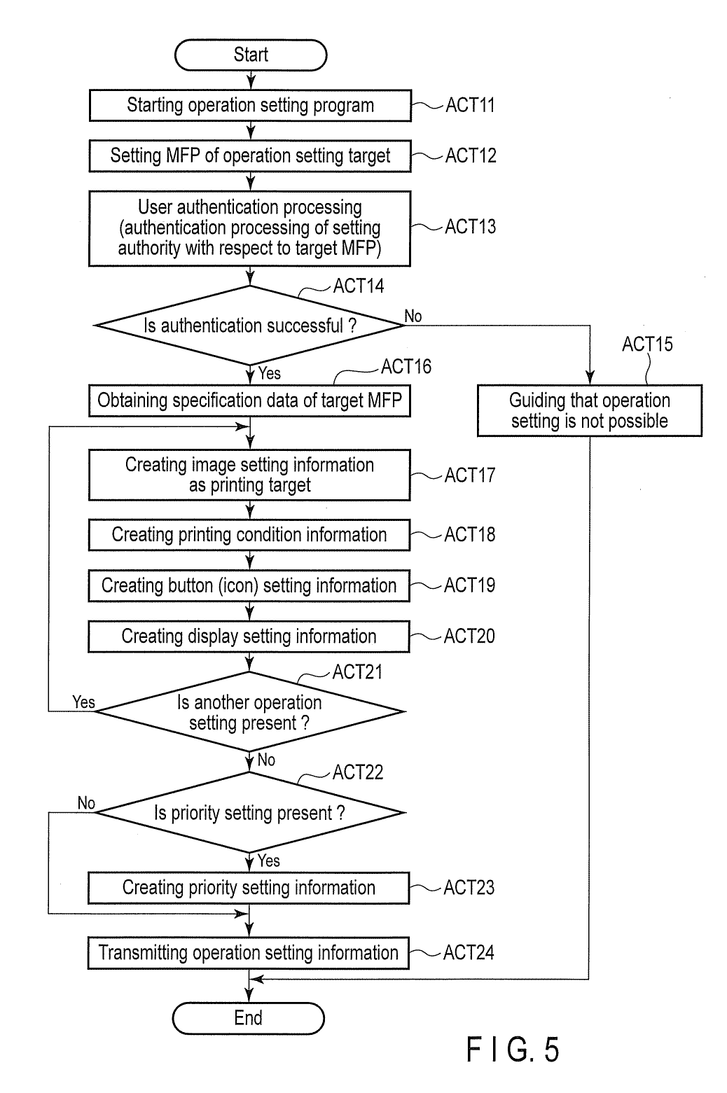

FIG. 5 is a flowchart which describes the generating processing of the operation setting information with respect to the MFP 2 in the external device 1.

First, the control unit 11 of the external device 1 starts up an operation setting program for performing the operation setting with respect to the MFP 2 (ACT 11). It is assumed that the operation setting program is installed in the external device 1 in advance. For example, the operation setting program is stored in an internal memory of the control unit 11, or the memory 12.

When the operation setting program is started, the control unit 11 sets the MFP 2 as a target of the operation setting (ACT 12). The control unit 11 sets one or more MFPs which are designated by a user (manager) using the operation unit 14 as a target of the operation setting. For example, the control unit 11 may display a list of the MFPs to which operation setting can be performed on the display unit 13, and may cause the operation unit 14 to select the MFP to which the operation setting is performed.

When the MFP as a target of the operation setting is set, the control unit 11 performs user authentication processing (confirming processing of authority of operation setting) of confirming whether or not a user who is operating the MFP has an authority of performing the operation setting with respect to the MFP as the operation setting target (ACT 13). The user authentication processing may be performed using authentication information which is registered in the MFP 2 or the server 3 by registering the authentication information of a user who can perform the operation setting in the MFP 2 or the server 3 in each MFP. In addition, in the user authentication processing, an authority level of a user may be managed in the server 3, and whether or not the user has the authority level of performing the operation setting with respect to the MFP 2 may be authenticated.

When the user authentication is failed (NO in ACT 14), the control unit 11 performs a guidance display on the display unit 13 that it is not possible to perform the operation setting with respect to the designated MFP (ACT 15), and finishes the processing using the operation setting program.

When the user authentication is successful (YES in ACT 14), the control unit 11 obtains specification data denoting functions, or the like, included in the MFP as a target (ACT 16). The specification data of the target MFP may be obtained from the MFP, may be obtained from the server, or may be stored in the memory in advance. When the specification data of the MFP is obtained, the control unit 11 sets the operation setting information denoting the operation setting contents with respect to the MFP according to the user operation (ACTs 17 to 23). Here, as the operation setting with respect to the MFP, a case will be assumed and described in which one or more printing processing which are designated by a user are set to one or more buttons will be described.

For example, the control unit 11 creates image information (image setting information) which is set as an image designated by a user as a printing target, using the operation unit 14 (ACT 17). The created image information is stored in the memory in the control unit 11, or the memory 12. The image information which designates an image as a printing target may be the image data as the printing target itself, or may be information in which the image data which is stored in the MFP 2 or the server 3 is designated using identification information such as a file name, or the like, or in which address information (address information of Web page as printing target) of the image data as a printing target may be set.

When the image information which sets an image as the printing target is created, the control unit 11 creates printing condition information which sets a printing condition designated by a user using the operation unit 14 as the printing condition of the image data to be printed (ACT 18). The created printing condition information is stored in the memory in the control unit 11, or the memory 12 by being correlated with the image information.

The printing condition information is information which designates printing conditions such as the number of copies to be printed, a size of a sheet, a type of a sheet, the printing surface (single sided printing or double sided printing), magnification, color (monochrome, color, erasable color), or the like. For example, the number of copies to be printed may be set in one operation (input to printing instruction button of once), or may be set so that a user can designate the number of copies using the numeric keypad 43B every time. In addition, the size of a sheet, the type of a sheet, the printing surface (single sided printing or double sided printing), the magnification, and the color (monochrome, color, erasable color) may be set to be fixed in advance, or may be set so that a user can select the printing condition every time.

When the printing condition information is created, the control unit 11 creates button setting information in which a button designated by a user using the operation unit 14 is set as a button which instructs executing of the printing processing in the printing condition information (ACT 19). The created button setting information is stored in the memory in the control unit 11, or the memory 12 by being correlated with the image information and the printing condition information.

Here, it is assumed that the button setting information sets an icon displayed on the display unit 44 as a button which instructs executing of the printing processing. In this case, a user designates shape, size, color, language, display contents or the like of the icon as the button which instructs executing of the printing processing. The control unit 11 creates information denoting the shape, the size, the color, the language, the display contents or the like of the icon which are designated (created) by a user as the button setting information. For example, each icon may be created when the control unit 11 executes a program for generating the icon.

The button setting information may be the setting contents in which one of the user setting buttons 43C which can be set by a user is allocated to the button instructing the printing processing of the image data which is denoted by the image information. That is, processing which is set with respect to the MFP 2 in the operation setting information may be set so as to be executed using an input to the user setting button 43C.

When the button setting information is created, the control unit 11 creates setting information (display setting information) of display data which is displayed as the operation screen on the display unit 44 of the MFP 2 (ACT 20). The created display setting information is stored in the memory in the control unit 11, or the memory 12 by being correlated with the image information, the printing condition information, and the button setting information.

For example, as the display setting information, a display position of the icon which is set in the button setting information, contents of the operation guidance message, a display position of the operation guidance, or the like are set. In addition, creating processing of the setting information of the display data which is displayed on the display unit 44 (processing of ACT 20) may be performed after completing the setting with respect to all of the printing processes (all of button setting).

When the display setting information is created, the control unit 11 determines whether or not to perform setting of another printing processing (ACT 21). When it is determined that the setting of another printing processing is performed (YES in ACT 21), the control unit 11 returns to the above ACT 17, and performs the setting of another printing processing according to the order of ACTs 17 to 20.

In addition, the control unit 11 determines whether or not to perform priority setting (limitation of executable function) with respect to the MFP 2 (ACT 22). Here, the priority setting is setting to limit functions which can be executed by the MFP as the target of the operation setting. The priority setting is set according to instructions by a user. For example, the priority setting may be setting in which processing other than the printing processes which are set in the above ACTs 17 to 21 is set so as not to be executed, or may be setting in which processing other than the printing processes which are set in the above ACTs 17 to 21, and a part of functions (for example, function of copying) which are designated by a user is set so as not to be executed. In addition, the priority setting may be setting in which a user other than the manager cannot perform processing other than the printing processing which is set in the above ACTs 17 to 21 (manager is able to perform).

That is, when a user designates the priority setting (YES in ACT 22), the control unit 11 sets the priority setting information for locking processing except the priority setting (ACT 23). The created priority setting information is stored in the memory in the control unit 11, or the memory 12 by being correlated with the image information, the printing condition information, the button setting information, the display setting information, or the like.

The pieces of information set in the above ACTs 17 to 23 (image information, printing condition information, button setting information, display setting information, and priority setting information) are generated as one operation setting information with respect to the MFP 2 as the operation setting target. When the generation of the operation setting information is completed, the control unit 11 transmits the generated operation setting information to the MFP 2 as the operation setting target through the network 4 (ACT 24).

The control unit 11 may directly transmit the operation setting information to the MFP 2, or may transmit the operation setting information to the MFP 2 through the server 3. If the operation setting information is transmitted to the MFP 2 through the server 3, the operation setting information is accumulated in the server 3 when a power supply of the MFP 2 as the target of the operations setting is turned off. The operation setting information which is accumulated in the server 3 may be transmitted to the MFP 2 from the server 3 when the power supply of the MFP 2 is turned on.

Subsequently, the operation setting processing in the MFP 2 will be described.

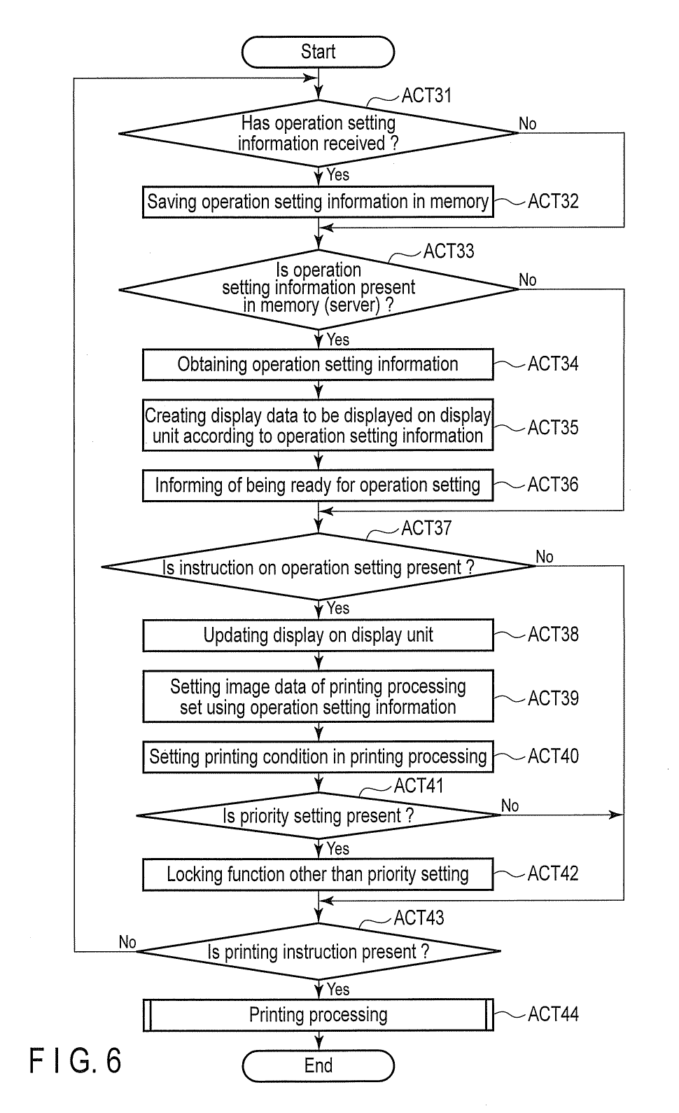

FIG. 6 is a flowchart which describes an example of the operation setting processing based on the operation setting information from the external device 1 in the MFP 2.

First, it is assumed that the operation setting information which is transmitted from the external device 1 is transmitted to the MFP 2. The MFP 2 receives the operation setting information through the communication unit 37 when it is a state in which the data can be received from the external device 1 (ACT 31). However, the MFP 2 may receive the operation setting information from the external device 1 through the server 3. In addition, when the MFP 2 is unable to receive the data due to an OFF state of the MFP 2, or the like, the server 3 may receive the operation setting information from the external device 1. In this case, the server 3 accumulates the received operation setting information in a state of being managed in each MFP 2 as the transmission destination. The MFP 2 receives the operation setting information from the server 3 after being in a state in which the data can be received due to an ON state of the MFP 2, or the like.

When the operation setting information is received from the external device 1 (YES in ACT 31), a control unit 31 saves the received operation setting information in a memory 32 (ACT 32). The control unit 31 takes in the operation setting information which is saved in the memory 32 at a predetermined time (for example, when power is supplied, or in READY state). That is, when the operation setting information is saved in the memory 32 (YES in ACT 33), the control unit 31 obtains the operation setting information from the memory 32 at a predetermined time (ACT 34).

In addition, when the operation setting information from the external device 1 is saved in the server 3, the control unit 31 of the MFP 2 inquires of the server 3 about whether or not the operation setting information with respect to the MFP 2 is present at a predetermined time (for example, when power is supplied, or in READY state). When information that the operation setting information is saved is received from the server 3 (YES in ACT 33), the control unit 31 obtains the operation setting information from the server 3 (ACT 34).

When the operation setting information is obtained, the control unit 31 creates display data to be displayed on the display unit 44 according to the button setting information and the display setting information which are included in the obtained operation setting information (ACT 35). The button setting information denoting set contents of each icon (button), and display setting information denoting a display position of the icon, message contents of the operation guidance, and a display position of the operation guidance are included in the operation setting information. The control unit 31 creates the display data as an operation screen including the icon for instructing processing which sets the operation using the information. The created display data is saved in a memory in the control unit 31, or in the memory 32.

When the display data to be displayed on the display unit 44 is created, the control unit 31 informs that it is ready to set operations using the operation setting information from the external device 1 (ACT 36). For example, the control unit 31 displays a guidance denoting that it is ready to set the operation on the display unit 44 of the control panel 24. In addition, it may be also possible to inform that it is ready to set operations using a speaker (not shown), or the like. When informing that it is ready to set the operations using the operation setting information from the external device 1, the control unit 31 is in a state of waiting for inputting of instruction on executing the operation setting by a user.

When the executing of the operation setting using the operation setting information from the external device 1 is instructed (YES in ACT 37), the control unit 31 updates the display contents on the display unit 44 to the display data which is created according to the operation setting information (ACT 38). For example, the control unit 31 supplies a request of updating the display of the display unit 44, and the display data which is created according to the operation setting information to the panel control unit 41. The panel control unit 41 saves the display data supplied from the control unit 31 in a memory 42, and displays the display data which is saved in the memory 42 on the display unit 44.

In addition, the control unit 31 updates the display contents of the display unit 44, and sets processing contents corresponding to the icon (set button) which is displayed on the display unit 44 based on the operation setting information (ACTs 39 and 40). As the setting of the processing contents corresponding to the icon which is set according to the operation setting information, the control unit 31 stores information which denotes the processing contents by causing the processing contents to be correlated with information denoting the icon (button), in the memory 32, or the memory 42.

That is, the control unit 31 stores information denoting image data as a printing target which is designated using the image setting information included in the operation setting information in the memory 32 by causing the information to be correlated with the information denoting the icon which is displayed on the display unit 44 (ACT 39). For example, when the image data itself as the printing target is included in the operation setting information, the control unit 31 stores the image data in an image memory 33 (or in memory 32). The control unit 31 stores information denoting the image data which is stored in the image memory 33 by causing the information to be correlated with the information denoting the icon which is displayed on the display unit 44 as the information denoting the processing contents in the memory 32.

In addition, when the image data as the printing target in the operation setting information is designated as identification information such as a file name of the image data which is stored in the storage unit such as the image memory 33, the control unit 31 stores the identification information denoting the image data as the printing target by causing the information to be correlated with the information denoting the icon as the information denoting the processing content. In addition, when the image data as the printing target in the operation setting information is designated as address information (address information of Web page to be printed), the control unit 31 stores the address information of the image data (for example, Web page) as the printing target as information denoting the processing contents by causing the information to be correlated with the information denoting the icon.

When the image data as the printing target is set, the control unit 31 further stores the information denoting the printing condition in the memory 32 as the information denoting the processing contents by causing the information to be correlated with the information denoting the icon which is displayed on the display unit 44 (ACT 40). The printing condition is designated using the printing condition information which is included in the operation setting information. For example, in the printing condition information, the number of copies to be printed, a size of sheet, a type of sheet, the printing surface, magnification, color, and the like are designated as the printing conditions. For this reason, the control unit 31 stores the information denoting the icon which is displayed on the display unit 44, information denoting the image data as the printing target, and information denoting the printing conditions which are designated in the printing condition information to be correlated with each other in the memory 32, as the information denoting the processing contents which are correlated with the information denoting the icon which is displayed on the display unit 44.

When the image data as the printing target, and the printing conditions are set with respect to the icon which is displayed on the display unit 44, the control unit 31 further determines whether or not the priority setting information is included in the operation setting information (ACT 41). When it is determined that the priority setting information is included in the operation setting information (YES in ACT 41), the control unit 31 locks processing other than the processing in which the priority setting is performed (ACT 42). In the priority setting using the priority setting information, processing other than the printing processing using the icon (button) which is set using the button setting information is set so as not to be executed, or processing other than the printing processing using the icon (button) which is set using the button setting information, and the function which is designated using the priority setting information are set so as not to be executed.

For example, when the priority setting information has set contents in which the processing other than the printing processing using the icon which is set using the button setting information is not executable, the control unit 31 sets the processing other than the printing processing using the icon which is set using the button setting information not to be executed. In addition, when the priority setting information has set contents in which processing other than the printing processing using the icon which is set using the button setting information, and the function designated using the priority setting information (e.g. function of copying) are set so as not to be executed, the control unit 31 sets processing other than the printing processing which is set using the operation setting information, and the function which is designated using the priority setting information so as not to be executed.

In the priority setting information, it may be possible to set the priority setting such that processing other than the set printing processing is not executable for a person other than a manager, and the processing other than the set printing processing is executable for the manager. In this case, the control unit 31 may set the priority setting such that when the processing other than the set printing processing is requested, the user authentication processing of determining whether or not the user is the manager is performed, and a user who is authenticated as the manager is able to perform the processing other than the set printing processing.

By performing the above ACTs 38 to 42, the operation setting processing based on the operation setting information from the external device is completed. When the operation setting processing is completed, the display data (operation screen) including the icon which is created according to the operation setting information from the external device (icon in which image to be printed, and printing conditions are set) is displayed on the display unit 44. In this state, the control unit 31 performs the printing processing of the processing contents which are set by being correlated with the icon according to the input to the icon which is displayed on the display unit 44.

That is, after completing the operation setting processing based on the operation setting information from the external device, the control unit 31 detects the presence of an input to the button (icon displayed on display unit 44) which is set according to the button setting information (ACT 43). When the input of instruction to the set button is detected (YES in ACT 43), the control unit 31 executes processing of the processing contents set by being correlated with the button (ACT 44).

According to the above image forming system, the MFP receives the operation setting information including the button setting information and the display setting information which are created in the external device, and updates the display of the display unit to the display contents which include the icon or the like which is set according to the received operation setting information. Further, the MFP sets the processing contents which are executed according to the input to the icon which is set using the button setting information based on the operation setting information. In this manner, in the MFP, the processing of the processing contents which are set in the external device using the icon which is set in the external device can be executed.

For example, according to the above image forming system, it is possible to execute an operation setting for printing a printed matter such as a brochure which is distributed to visitors or attendants with respect to the MFP which is provided in a conference hall, an exhibition hall, a concert hall, and a variety of event halls from the external device. As a result, a work of printing the printed matter in advance, or the like, is not necessary, and it is possible to provide the printed matter neither too much, nor too little. In addition, since the operation screen including the icon which is displayed on the display unit of the MFP can be customized from the external device, it is possible to provide an operation screen including the icon which is created in the external device according to the usage. In addition, since the operation setting with respect to the MFP (setting of printing contents) can be performed from the external device, it is possible to rapidly perform a change of the printing contents or the like with respect to the MFP from a distant place.

In addition, in the above image forming system, as the processing contents which are correlated with the icon or the button which is set using the button setting information in the MFP, it is possible to set not only the image data itself, but the image such as a Web page which is specified using the address information on the network as the printing target. For example, when the Web page showing the weather information, the traffic information, the regional information, and the state of emergency is set as the printing target, the MFP is able to perform printing according to the input to the icon or the button to which the latest weather information, traffic information, regional information, and state of emergency which are shown on the Web.

In addition, in the above image forming system, as the processing contents which are correlated with the icon or the button which is set using the button setting information in the MFP, it is possible to set the detailed printing conditions (number of copies to be printed, size of sheet, type of sheet, printing surface, magnification, color, or the like). For example, since it is possible to set the number of copies to be printed to a predetermined number of copies, or to set the number of copies to be printed so that a user designates the number of copies every time, the number of copies to be printed using an input to a button (icon) once can be set to an appropriate number of copied depending on the operation form.

In addition, in the above image forming system, the external device is able to create the priority setting information in which the processing other than the processing using the button which is set using the operation setting information is set so as not to be executed, or the processing other than the processing using the set button and a part of functions is set so as not to be executed, and in the MFP, it is possible to limit the operation according to the priority setting information which is included in the operation setting information.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a reception unit which receives operation setting information including image information of a printing target, printing condition information, and button setting information from an external device;
a button setting unit which sets a printing instruction button using the button setting information which is included in the operation setting information received by the reception unit;
a setting unit which sets processing contents based on the image information and the printing condition information by causing the processing contents to be correlated with the printing instruction button which is set by the button setting unit; and
a printing unit which prints image data which is denoted in the image information according to the printing condition, when the printing instruction button is input.

2. The apparatus according to claim 1, further comprising:
a display unit which displays an icon,
wherein the printing instruction button which is set using the button setting information is the icon which is displayed in the display unit.

3. The apparatus according to claim 1, wherein the button setting unit creates an icon as the printing instruction button using the button setting information, and the apparatus further comprises:
a creating unit which creates display data including the icon which is created using the button setting unit; and
a display unit which displays the display data including the icon which is created using the creating unit.

4. The apparatus according to claim 2,
wherein the display unit is a touch panel-type operation display unit which is mounted with an instruction button which performs a printing instruction and operates an image forming apparatus, and a button which performs a printing operation using the icon.

5. The apparatus according to claim 1, further comprising:
a communication unit which accesses a Web page on a network,
wherein the image information is address information to access the Web page,
wherein the storage unit stores the address information and the printing condition information to be correlated with each other, in the printing instruction button, and
wherein the printing unit prints the Web page of the address information which is accessed through the communication unit according to the printing condition, when the printing instruction button is input.

6. The apparatus according to claim 1, wherein the operation setting information which is received by the reception unit further includes priority setting information in which processing other than the printing processing of the image information is set so as not to be executed, and the apparatus further comprises:
a priority setting unit which sets processing other than printing processing of the image information which is correlated with the printing instruction button so as not to be executed.

7. The apparatus according to claim 6,
wherein the priority setting unit makes an input to the printing instruction button valid, and makes an input to buttons other than the printing instruction button invalid.

8. The apparatus according to claim 6,
wherein the priority setting information is setting information in which processing other than the printing processing of the image information and a function designated using the priority setting information is set so as not to be executed, and
wherein the priority setting unit sets processing other than the printing processing of the image information and the function which is designated using the priority setting information so as not to be executed.

9. An image forming system comprising:
an external device; and
an image forming apparatus,
the external device comprises,
a creating unit which creates operation setting information including image information of a printing target, printing condition information, and button setting information as information denoting operation setting which instructs the image forming apparatus; and
a transmission unit which transmits the operation setting information which is created in the creating unit to the image forming apparatus, and
the image forming apparatus comprises,
a reception unit which receives the operation setting information which is transmitted from the external device;
a button setting unit which sets a printing instruction button using button setting information which is included in the operation setting information received by the reception unit;
a storage unit which stores the image information and the printing condition information in the printing instruction button which is set by the button setting unit to be correlated with each other; and
a printing unit which prints image data which is denoted in the image information according to the printing condition when the printing instruction button is input.

10. A method of operation setting of an image forming apparatus comprising:
receiving operation setting information including image information of a printing target, printing condition information, and button setting information from an external device;
setting printing instruction button using the button setting information which is included in the received operation setting information;
storing the image information and the printing condition information in the set printing instruction button to be correlated with each other; and
printing image data which is denoted in the image information according to the printing condition, when the printing instruction button is input.
